(19) United States
(12) Patent Application Publication
(10) Pub. No.: US 2024/0260158 A1
(43) Pub. Date: Aug. 1, 2024

(54) STREET LIGHT SYSTEM, STREET LIGHT MANAGEMENT METHOD AND NONTRANSITORY STORAGE MEDIUM

(71) Applicant: NEC Corporation, Minato-ku, Tokyo (JP)

(72) Inventors: Bantaro WATARI, Tokyo (JP); Akira KOZAWA, Tokyo (JP); Tsuyoshi SUGO, Tokyo (JP); Sae WATANABE, Tokyo (JP); Gengo NAKAGAWA, Tokyo (JP)

(73) Assignee: NEC Corporation, Minato-ku, Tokyo (JP)

(21) Appl. No.: 18/564,663

(22) PCT Filed: Jan. 4, 2022
(86) PCT No.: PCT/JP2022/000028

§ 371 Date: Nov. 28, 2023

(30) Foreign Application Priority Data
May 31, 2021 (JP) 2021-091383

(51) Int. Cl. H05B 47/125; G06T 7/20; G06V 20/52; G06V 20/54; G06V 40/10

(52) U.S. Cl. CPC H05B 47/125; G06T 7/20; G06V 20/53; G06V 20/54; G06V 40/10; G06T 2207/30196; G06T 2207/30236; G06V 2201/08

(57) ABSTRACT

A street light system (100) includes street lights (101_1) to (101_20) that generate person information relating to a plurality of persons included in image information by processing the image information to be generated by a camera (111), and a management apparatus (102) that controls a lighting state of an illumination (113) provided in at least one of the street lights (101_1) to (101_20) by using a processing result of the image information.

### TECHNICAL FIELD

The present invention relates to a street light system, a street light, a street light management method, and a program.

### BACKGROUND ART

For example, PTL 1 discloses a street light system including a sensor unit and a street light unit.

The sensor unit described in PTL 1 includes a detection means for detecting a moving object, a storage means for storing position information in which a position of an installation place of the sensor unit is defined by at least one or more coordinate systems, and a transmission means for transmitting, to another unit, moving object detection information including the position information in a case where the moving object is detected.

The street light unit described in PTL 1 includes an illumination means for illuminating surroundings, a reception means for receiving moving object detection information from the sensor unit, and a control means for controlling on and off of the illumination means by a predetermined lighting condition according to a coordinate system, in a case where the moving object detection information is received, and a position of the sensor unit based on the position information lies within a predetermined area in the coordinate system in which the position information is defined.

PTL 1 describes that, according to the invention described in the document, it is possible to perform lighting control according to a coordinate system in an overlap area where an area in which a street light system having a different coordinate system is installed overlaps, and it is easy to introduce the street light system, for example, in a town unit.

### RELATED DOCUMENT

### Patent Document

PTL 1: Japanese Patent Application Publication No. 2014-225377

### DISCLOSURE OF THE INVENTION

### Technical Problem

However, in the invention described in PTL 1, a technique for allowing a moving object such as a person to safely pass is hardly disclosed.

The present invention has been made in view of the above-described circumstances, and one of objects of the present invention is to improve safety of passage.

### Solution to Problem

In order to achieve the above-described object, a street light system according to a first aspect of the present invention includes:
an image processing unit that generates person information relating to a plurality of persons included in image information by processing the image information to be generated by a camera provided in each of one or a plurality of street lights; and
an illumination management unit that controls a lighting state of an illumination provided in at least one of the one or the plurality of street lights by using a processing result of the image information.

In order to achieve the above-described object, a street light management method according to a second aspect of the present invention includes:
causing a controller provided in each of one or a plurality of street lights to generate person information relating to a plurality of persons included in image information by processing the image information to be generated by a camera provided in each of one or a plurality of street lights; and
causing a management apparatus capable of mutually communicating with the controller to control a lighting state of an illumination provided in at least one of the one or the plurality of street lights by using a processing result of the image information.

In order to achieve the above-described object, a program according to a third aspect of the present invention includes:
a program for causing a controller provided in each of one or a plurality of street lights to generate person information relating to a plurality of persons included in image information by processing the image information to be generated by a camera provided in each of one or a plurality of street lights; and
a program for causing a management apparatus capable of mutually communicating with the controller to control a lighting state of an illumination provided in at least one of the one or the plurality of street lights by using a processing result of the image information.

### Advantageous Effects of Invention

The present invention enables improving safety of passage.

### BRIEF DESCRIPTION OF THE DRAWINGS

FIG. 1 is a diagram illustrating a configuration example of a street light system according to one example embodiment of the present invention.

FIG. 2 is a diagram illustrating a layout example of street lights according to the one example embodiment.

FIG. 3 is a diagram illustrating one example of an external appearance of a street light according to the one example embodiment.

FIG. 4 is a diagram illustrating a functional configuration of a controller included in the street light according to the one example embodiment.

FIG. 5 is a diagram illustrating a functional configuration of a management apparatus according to the one example embodiment.

FIG. 6 is a diagram illustrating a physical configuration of the controller included in the street light according to the one example embodiment.

FIG. 7 is a diagram illustrating a physical configuration of the management apparatus according to the one example embodiment.

FIG. 8 is a flowchart illustrating one example of first information transmission processing according to the one example embodiment of the present invention.

FIG. 9 is a flowchart illustrating one example of second information transmission processing according to the one example embodiment of the present invention.

FIG. 10 is a flowchart illustrating one example of illumination management processing according to the one example embodiment of the present invention.

FIG. 11 is a flowchart illustrating one example of output management processing according to the one example embodiment of the present invention.

FIG. 12 is a flowchart illustrating one example of illumination control processing according to the one example embodiment of the present invention.

FIG. 13 is a flowchart illustrating one example of output control processing according to the one example embodiment of the present invention.

FIG. 14 is a flowchart illustrating one example of operation state control processing according to the one example embodiment of the present invention.

FIG. 15 is a diagram illustrating one example of an external appearance of a street light according to a modification example 4.

### DESCRIPTION OF EMBODIMENTS

In the following, one example embodiment according to the present invention is described by using the drawings. Note that, in all of the drawings, a similar constituent element is designated by a similar reference sign, and description thereof is omitted as necessary.

### <<Configuration of Street Light System 100>>

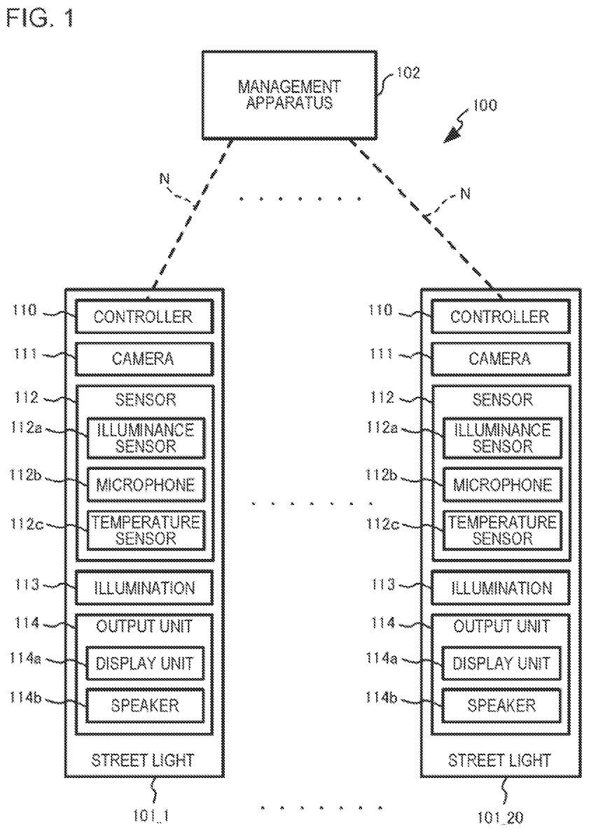

A street light system 100 according to one example embodiment of the present invention is, as illustrated in a configuration example in FIG. 1, a system for managing a plurality of street lights 101_1 to 101_20 to be installed on a road. The street light system 100 includes the street lights 101_1 to 101_20, and a management apparatus 102 for managing the street lights 101_1 to 101_20.

The management apparatus 102 is configured to be able to mutually communicate with each of the street lights 101_1 to 101_20 via a network N configured by wired connection, wireless connection, or combining these.

Hereinafter, the street lights 101_1 to 101_20 are also simply described as “street lights 101”, in a case where each of the street lights is not specifically distinguished.

### (Configuration of Street Light 101)

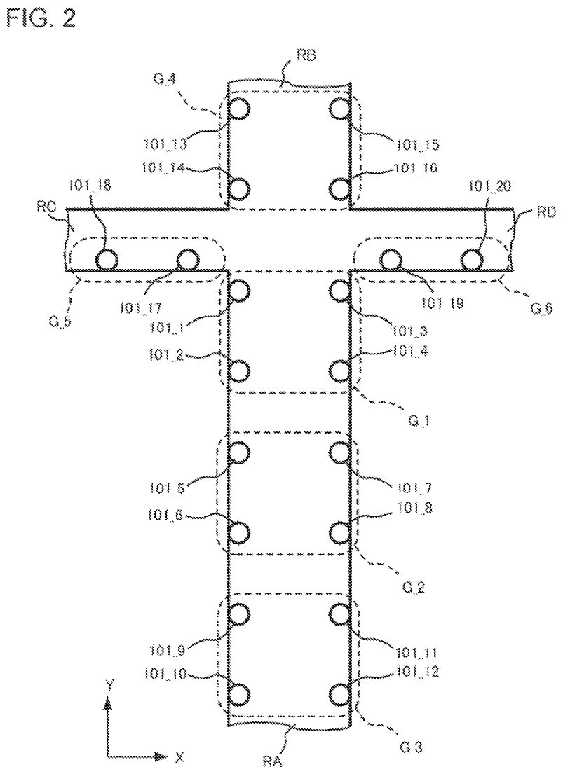

As illustrated in a layout example in FIG. 2, the street lights 101_1 to 101_20 are installed on roads RA to RD. In the example illustrated in FIG. 2, the street lights 101_1 to 101_16 are arranged along the road RA and the road RB extending along a Y axis direction. The street lights 101_17 to 101_20 are arranged along the road RC and the road RD extending along an X axis and intersecting the road RA and the road RB.

The street lights 101_1 to 101_20 are grouped according to an area on a road where each of the street lights is installed. In the example illustrated in FIG. 2, the street lights 101_1 to 101_4 are grouped into a group 1, the street lights 101_5 to 101_8 are grouped into a group 2, the street lights 101_9 to 101_12 are grouped into a group 3, and the street lights 101_13 to 101_16 are grouped into a group 4. Further, the street lights 101_17 to 101_18 are grouped into a group 5, and the street lights 101_19 to 101_20 are grouped into a group 6.

Note that, the street light system 100 may include at least one street light 101 to be managed by the management apparatus 102. Further, in a case where the plurality of street lights 101 are grouped, at least one street light 101 may be included in each group.

As illustrated in FIG. 1, each of the street lights 101 includes a controller 110, a camera 111, a sensor 112, an illumination 113, and an output unit 114.

The controller 110 controls the street light 101. A functional configuration of the controller 110 is described later with reference to a drawing.

The camera 111 sequentially photographs a surrounding road, and generates image information indicating a photographed moving image. Note that, the camera 111 may generate a still image by photographing at a predetermined timing under the control of the controller 110.

A substantially entirety of a road near an area where the street lights 101_1 to 101_20 are provided is photographed by the entirety of the cameras 111 provided in the street lights 101_1 to 101_20. Note that, a predetermined area such as an area where a person is passing may be photographed on a road near an area where the street lights 101_1 to 101_20 are provided by the entirety of the cameras 111 provided in the street lights 101_1 to 101_20.

The sensor 112 includes an illuminance sensor 112a, a microphone 112b, and a temperature sensor 112c. The illuminance sensor 112a measures ambient brightness, and outputs illuminance information including a measured illuminance. The microphone 112b detects an ambient sound, and outputs sound information including the detected sound. The temperature sensor 112c measures a temperature inside a housing of the street light 101, and outputs temperature information including the measured temperature.

The illumination 113 is a member for illuminating a surrounding road with light. The illumination 113 is constituted of, for example, a light emitting diode (LED), a fluorescent lamp, or the like.

The output unit 114 is a member for informing a person passing on a road of information, and includes a display unit 114a and a speaker 114b.

The display unit 114a is a member for informing information by means of an image. The display unit 114a is constituted of, for example, an LED vision or the like in which a liquid crystal panel or a light emitting diode (LED) is a light source. Note that, the display unit 114a may be a projector for projecting an image on a predetermined projection plane such as a road surface of a road, or another street light 101. In a case where an image is projected on another street light 101, for example, a side surface of the street light 101 provided next to a street light 101 is preferable as a projection plane.

The speaker 114b is a member for informing information by means of a sound.

Note that, the output unit 114 may include at least either of the display unit 114a, and the speaker 114b.

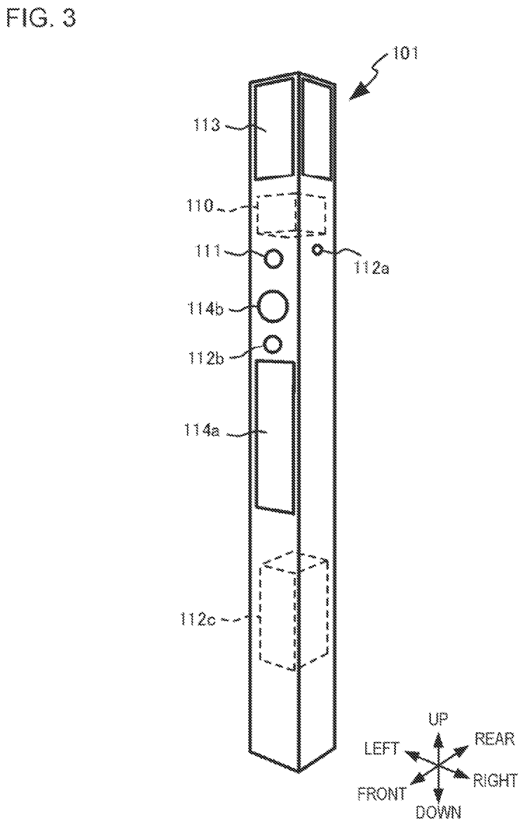

FIG. 3 illustrates one example of an external appearance of the street light 101. As illustrated in FIG. 3, the street light 101 includes an elongated prismatic housing substantially extending in an up-down direction; and the illumination 113, the controller 110, the camera 111, the illuminance sensor 112a, the speaker 114b, the microphone 112b, the display unit 114a, and the temperature sensor 112c are provided in the housing in order from the top. The controller 110 and the temperature sensor 112c may be provided inside the housing.

Although not illustrated, as a power source for operating the street light 101, for example, a commercial power supply may be utilized, or electric power generated in either or both of a photovoltaic panel and a windmill provided on the street light 101 may be utilized. In a case where electric power to be generated by a photovoltaic panel or a windmill is utilized for operating the street light 101, the street light 101 may further include a storage battery for storing the generated electric power, and may be operated by the electric power of the storage battery.

### (Functional Configuration of Controller 110)

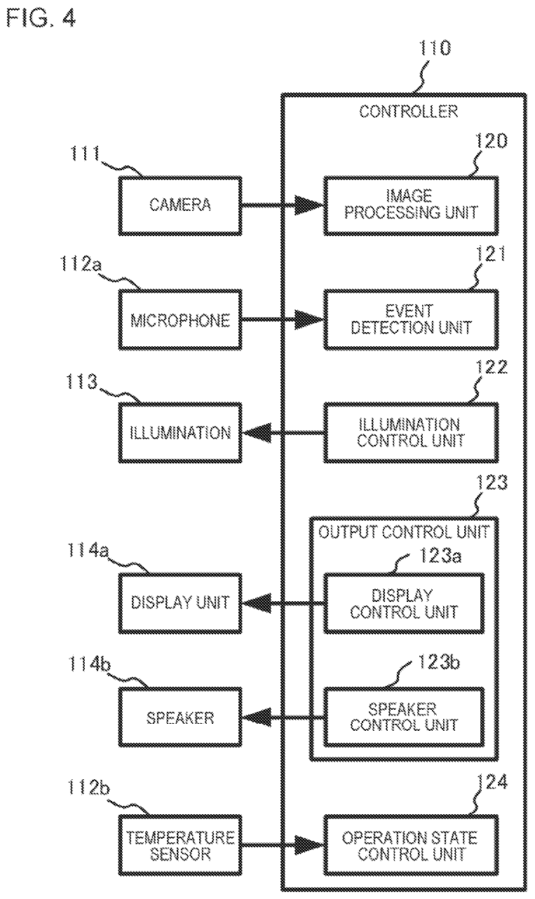

As illustrated in FIG. 4, the controller 110 functionally includes an image processing unit 120, an event detection unit 121, an illumination control unit 122, an output control unit 123, and an operation state control unit 124.

The image processing unit 120 generates person information relating to a plurality of persons included in image information by processing the image information to be generated by the camera 111. The image processing unit 120 transmits the generated person information to the management apparatus 102 via the network N.

The person information includes at least one of (1) information indicating presence or absence of a person, (2) people flow information, (3) object information relating to an object carried by a person, (4) a congestion degree indicating a degree of congestion of people, (5) wheelchair information relating to a person moving in a wheelchair, and (6) attribute information indicating an attribute of a person.

(2) People flow information is information relating to a flow of people. The people flow information includes at least one of information (movement information) relating to movement of a person, information (stop information) on a person stopping at a fixed place, and the like. The movement information includes at least one of a line of flow of people, a moving direction, a moving velocity, and the like. The stop information includes at least one of a place (stop place) where a person is stopping, a time (stop time) when a person is stopping, and the like.

(3) Object information includes at least one of information indicating whether a person is wearing a covering object such as a mask for covering around the mouth, information indicating whether a person is opening an umbrella, and the like. (4) Congestion degree is, for example, represented by the number of people being present in a fixed area such as a photographing area of the camera 111.

(5) Wheelchair information includes information relating to presence or absence of a person moving in a wheelchair. The wheelchair information may include a moving direction of a person moving in a wheelchair, and further include a moving velocity thereof.

An attribute included in (6) attribute information includes at least one of a gender and an age group, such as whether the person is a predetermined person or a suspicious person. For example, the person information may include people flow information for each attribute of a person.

The predetermined person is, for example, a very important person (VIP), a criminal, and the like.

The suspicious person is, for example, a person in ambush, a tracker, or a person carrying a knife. For example, in a case where there is a person staying at a fixed place for a time longer than a predetermined time, the person is detected as a person in ambush. For example, in a case where there is a person walking behind a person for a distance longer than a predetermined distance, the person is detected as a tracker.

Further, the image processing unit 120 generates vehicle information relating to movement of a vehicle included in image information by processing the image information to be generated by the camera 111. The vehicle is an automobile, a bicycle, or the like. The image processing unit 120 transmits the generated vehicle information to the management apparatus 102 via the network N.

Note that, image information may include only one person, and the image processing unit 120 may generate person information relating to the one person included in the image information.

Herein, the image processing unit 120 may generate person information, and vehicle information from image information by using a conventional image processing technique.

The conventional image processing technique is, for example, pattern matching. Reference image information for pattern matching is held in advance in the image processing unit 120.

Further, the conventional image processing technique is, for example, image processing using machine learning. In this case, the image processing unit 120 may generate person information or vehicle information by inputting image information to be generated by the camera 111 to a learned learning model in which machine learning for generating the person information or the vehicle information has been performed.

Input data to a learning model at a learning time are image information acquired by photographing a road. Then, in machine learning, for example, supervised learning using a correct answer according to a content of person information or vehicle information may be performed.

The event detection unit 121 detects occurrence of a predetermined event by using sensor information from the sensor 112. When the event detection unit 121 detects occurrence of a predetermined event, the event detection unit 121 generates event occurrence information indicating occurrence of the event, and transmits the generated event occurrence information to the management apparatus 102 via the network N.

More specifically, for example, the event detection unit 121 detects, as a predetermined event, a sudden braking of a vehicle, a scream, or firing of a gun by using sound information from the microphone 112b.

Herein, the event detection unit 121 may detect occurrence of a predetermined event from sound information, and generate event occurrence information by using a conventional audio processing technique.

For example, the event detection unit 121 may derive a degree of similarity with respect to reference information prepared in advance for each event, and in a case where the derived degree of similarity is equal to or more than a threshold value, may detect occurrence of an event. The reference information may be held in advance in the event detection unit 121.

Further, for example, the event detection unit 121 may detect occurrence of an event by audio processing using machine learning. In this case, the event detection unit 121 may generate event occurrence information by inputting sound information to a learned learning model in which machine learning for generating event occurrence information has been performed.

Input data to a learning model at a learning time are sound information generated by the microphone 112a. Then, in machine learning, for example, supervised learning using a correct answer according to sound information may be performed.

The illumination control unit 122 receives illumination control information to be transmitted from the management apparatus 102, and controls a lighting state of the illumination 113 according to the received illumination control information.

The illumination control information includes at least one of information indicating brightness with which the illumination 113 is turned on, information indicating either blinking or continuous lighting, information indicating a blinking pattern in case of blinking, and information indicating a color of light in case of blinking or continuous lighting. Therefore, a lighting state includes at least one of brightness of the illumination 113, blinking or continuous lighting, a blinking pattern in case of blinking, and a color.

The output control unit 123 receives output control information to be transmitted from the management apparatus 102, and controls the output unit 114 according to the received output control information.

More specifically, the output control unit 123 includes a display control unit 123a, and a speaker control unit 123b. The display control unit 123a causes the display unit 114a to display an image according to output control information. The speaker control unit 123b causes the speaker 114b to output an audio sound according to output control information.

The operation state control unit 124 controls an operation state of the controller 110, based on temperature information from the temperature sensor 112c.

More specifically, in a case where a temperature included in temperature information is equal to or more than a first threshold value T1 [° C.], the operation state control unit 124 sets an operation state of the controller 110 to a standby state. In a case where a temperature included in temperature information received in a standby state is equal to or less than a second threshold value T2 [° C.], the operation state control unit 124 sets an operation state of the controller 110 to a normal state. However, T2 [° C.]<T1 [° C.].

The standby state is a state capable of performing only a predetermined piece of processing among pieces of processing to be performed by the controller 110. The predetermined piece of processing includes processing of acquiring temperature information received in a standby state, and setting an operation state of the controller 110 to a normal state, in a case where the temperature is equal to or less than the second threshold value T2 [° C.].

The normal state is a state capable of performing all pieces of processing to be performed by the controller 110.

Since the number of pieces of processing to be performed in a standby state decreases as compared with a normal state, it is possible to lower the temperature of the controller 110 by reducing heat dissipation accompanied by processing in the controller 110.

### Functional Configuration of Management Apparatus 102

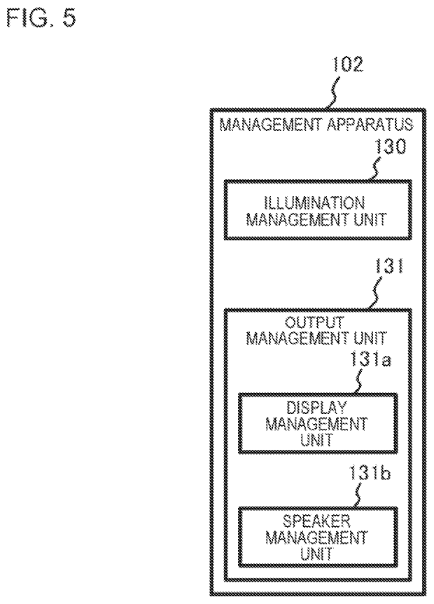

The management apparatus 102 is an apparatus for controlling the street light 101 by communicating with the street light 101 via the network N, and, as illustrated in FIG. 5, functionally includes an illumination management unit 130, and an output management unit 131.

The illumination management unit 130 generates illumination control information, based on person information, vehicle information, and event occurrence information, and transmits the generated illumination control information to the controller 110 via the network N. Thus, the illumination management unit 130 controls a lighting state of the illumination 113.

More specifically, for example, the illumination management unit 130 acquires, as a processing result of image information, person information and vehicle information transmitted from the image processing unit 120. The illumination management unit 130 generates illumination control information by using a processing result of image information.

The illumination management unit 130 transmits the generated illumination control information to the controller 110 of the target street light 101. Thus, the illumination management unit 130 controls a lighting state of the illumination 113 provided in the target street light 101 by using a processing result of image information.

Further, for example, when the illumination management unit 130 acquires event occurrence information transmitted from the event detection unit 121, the illumination management unit 130 generates illumination control information by using the acquired event occurrence information. The illumination management unit 130 transmits the generated illumination control information to the controller 110 of the target street light 101. Thus, the illumination management unit 130 controls a lighting state of the illumination 113 provided in the target street light 101, in a case where occurrence of an event has been detected by the event detection unit 121.

The illumination management unit 130 according to the present example embodiment transmits generated illumination control information to the controllers 110 of the street lights 101 belonging to the target groups G1 to G6. Thus, the illumination management unit 130 controls a lighting state of the illuminations 113 provided in the street lights 101 in a batch manner for each of the groups G1 to G6 by using a processing result of image information, or in a case where occurrence of an event has been detected by the event detection unit 121.

The output management unit 131 generates output control information, based on person information, vehicle information, and event occurrence information, and transmits the generated output control information to the controller 110 via the network N. Thus, the illumination management unit 130 controls the output unit 114.

More specifically, the output management unit 131 acquires, as a processing result of image information, person information and vehicle information transmitted from the image processing unit 120. The output management unit 131 generates output control information by using a processing result of image information.

The output management unit 131 transmits the generated output control information to the controller 110 of the target street light 101. Thus, the illumination management unit 130 controls the output unit 114 provided in the target street light 101 by using a processing result of image information.

Further, for example, when the output management unit 131 acquires event occurrence information transmitted from the event detection unit 121, the output management unit 131 generates output control information by using the acquired event occurrence information. The output management unit 131 transmits the generated output control information to the controller 110 of the target street light 101. Thus, the output management unit 131 controls the output unit 114 provided in the target street light 101, in a case where occurrence of an event has been detected by the event detection unit 121.

### (Physical Configuration of Controller 110)

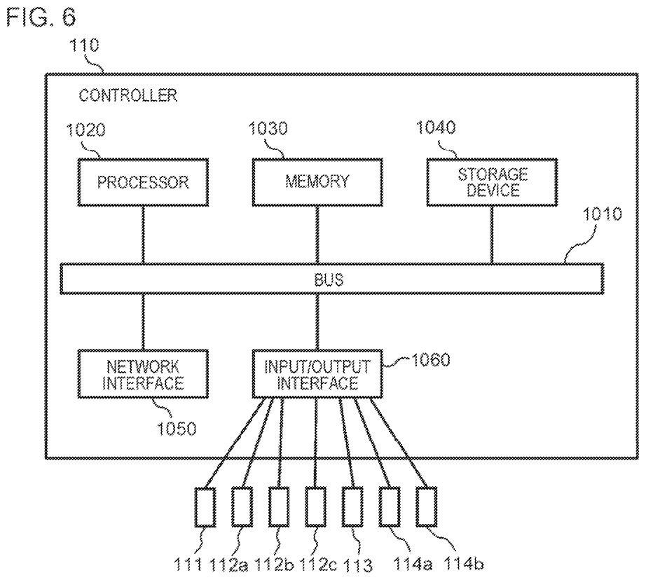

As illustrated in FIG. 6, the controller 110 physically includes a bus 1010, a processor 1020, a memory 1030, a storage device 1040, a network interface 1050, and an input/output interface 1060.

The bus 1010 is a data transmission path along which the processor 1020, the memory 1030, the storage device 1040, the network interface 1050, and the input/output interface 1060 mutually transmit and receive data. However, a method of mutually connecting the processor 1020 and the like is not limited to bus connection.

The processor 1020 is a processor to be achieved by a central processing unit (CPU), a graphics processing unit (GPU), or the like.

The memory 1030 is a main storage apparatus to be achieved by a random access memory (RAM) or the like.

The storage device 1040 is an auxiliary storage apparatus to be achieved by a hard disk drive (HDD), a solid state drive (SSD), a memory card, a read only memory (ROM), or the like. The storage device 1040 stores a program module for achieving each functional unit of the controller 110. The processor 1020 achieves each functional unit associated with each program module by reading each of these program modules in the memory 1030 and executing each of these program modules.

The network interface 1050 is an interface for connecting the controller 110 to the network N.

The input/output interface 1060 is an interface to which each piece of equipment (in the present example embodiment, the camera 111, the illuminance sensor 112a, the microphone 112b, the temperature sensor 112c, the illumination 113, the display unit 114a, and the speaker 114b) is connected.

### (Physical Configuration of Management Apparatus 102)

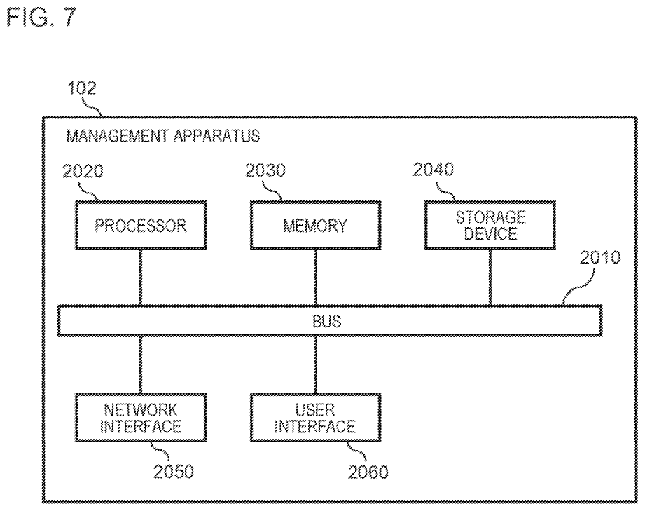

As illustrated in FIG. 7, the management apparatus 102 physically includes a bus 2010, a processor 2020, a memory 2030, a storage device 2040, a network interface 2050, and a user interface 2060.

The bus 2010 is a data transmission path along which the processor 2020, the memory 2030, the storage device 2040, the network interface 2050, and the user interface 2060 mutually transmit and receive data. However, a method of mutually connecting the processor 1020 and the like is not limited to bus connection.

The processor 1020 is a processor to be achieved by a CPU, a GPU, or the like.

The memory 1030 is a main storage apparatus to be achieved by a RAM or the like.

The storage device 1040 is an auxiliary storage apparatus to be achieved by a HDD, an SSD, a memory card, a ROM, or the like. The storage device 1040 stores a program module for achieving each functional unit of the management apparatus 102. The processor 1020 achieves each functional unit associated with each program module by reading each of these program modules in the memory 1030 and executing each of these program modules.

The network interface 2050 is an interface for connecting the management apparatus 102 to the network N.

The user interface 2060 is a touch panel, a keyboard, a mouse or the like as an interface for inputting information by the user, and a liquid crystal panel or the like as an interface for presenting information to the user.

### <<Operation of Street Light System 100>>

Hereinafter, an operation of the street light system 100 is described with reference to the drawings.

Street light management processing is processing to be performed by the street light system 100 for managing the street light 101. The street light management processing includes processing to be performed by the street light 101, and processing to be performed by the management apparatus 102. The processing to be performed by the street light 101 includes first information transmission processing, second information transmission processing, illumination control processing, output control processing, and operation state control processing. The processing to be performed by the management apparatus 102 includes illumination management processing, and output management processing.

The first information transmission processing, the second information transmission processing, the illumination management processing, the output management processing, the illumination control processing, and the output control processing are started when an illuminance included in illuminance information becomes equal to or less than a predetermined reference value, such as when it becomes evening or the like. These pieces of processing are performed in a state that communication is established between the controller 110 and the management apparatus 102.

### (First Information Transmission Processing)

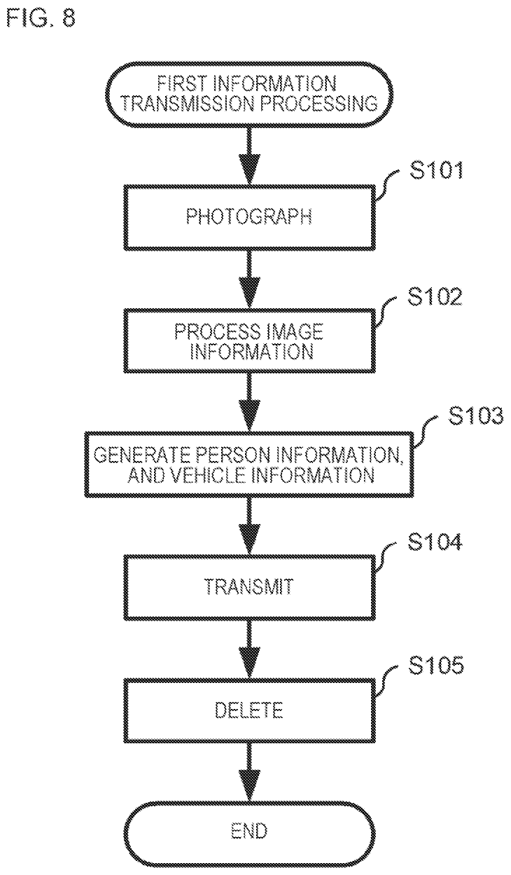

FIG. 8 is a flowchart illustrating one example of the first information transmission processing according to the present example embodiment. The first information transmission processing is processing for transmitting a processing result of image information to the management apparatus 102, and is performed by each of the street lights 101.

The camera 111 photographs a road (step S101). Thus, the camera 111 generates image information indicating a photographed image.

The image processing unit 120 processes the image information generated in step S101 (step S102).

The image processing unit 120 generates, as a processing result of the image information in step S102, person information relating to a plurality of persons included in the image information, and vehicle information relating to movement of a vehicle included in the image information (step S103).

The image processing unit 120 transmits the person information and the vehicle information generated in step S103 to the management apparatus 102 via the network N (step S104).

The image processing unit 120 deletes the image information generated in step S101 (step S105), and finishes the first information transmission processing.

In step S104, image information itself is not transmitted to the management apparatus 102, but a processing result of the image information is transmitted to the management apparatus 102. It is almost impossible to determine a person included in the image information from a processing result of the image information. Thus, the image information is erased. Therefore, there is no likelihood that personal information indicating a location of a person included in the image information leaks through the network N, or is left in a storage apparatus. This enables to protect personal information.

### (Second Information Transmission Processing)

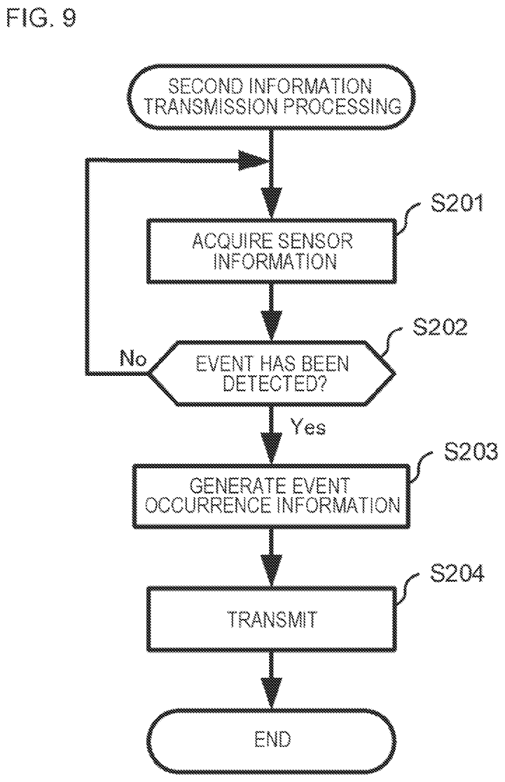

FIG. 9 is a flowchart illustrating one example of the second information transmission processing according to the present example embodiment. The second information transmission processing is processing for transmitting event occurrence information to the management apparatus 102, and is performed by each of the street lights 101.

The event detection unit 121 acquires sensor information from the sensor 112 (step S201). In the present example embodiment, the event detection unit 121 acquires sound information sound information as sensor information from the microphone 112a.

The event detection unit 121 determines whether an event has been detected from the sensor information acquired in step S201 (step S202). In a case where an event has been detected (step S202; No), processing of step S201 is performed again.

In a case where an event has not been detected (step S202; No), the event detection unit 121 generates event occurrence information according to the detected event (step S203).

Event occurrence information may include only that an event has occurred, and, for example, may include a content of an occurring event such as a sudden braking of a vehicle, a scream, or firing of a gun.

The event detection unit 121 transmits the event occurrence information generated in step S203 to the management apparatus 102 via the network N (step S204), and finishes the second information transmission processing.

The first information transmission processing and the second information transmission processing may be concurrently performed, or may be repeatedly performed in order.

### (Illumination Management Processing)

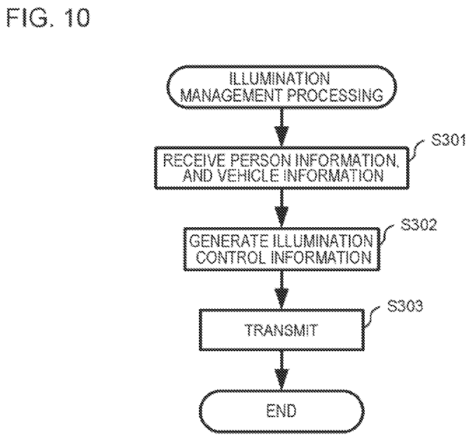

FIG. 10 is a flowchart illustrating one example of the illumination management processing according to the present example embodiment. The illumination management processing is processing for controlling the illumination 113 provided in the target street light 101, and is performed by the management apparatus 102.

The illumination management unit 130 receives person information, vehicle information, and event occurrence information transmitted in steps S104 and S204 via the network N (step S301). The illumination management unit 130 holds the received person information and vehicle information.

The illumination management unit 130 generates illumination control information for controlling a lighting state of the illumination 113 provided in the target street light 101, based on the person information and the vehicle information received in step S301 (step S302).

More specifically, for example, the illumination management unit 130 holds in advance an illumination control rule in which a control method of the illumination 113 according to person information and vehicle information is defined. The illumination management unit 130 determines the street light 101 to be controlled by applying the street light 101 serving as a transmission source of these pieces of information being the person information and the vehicle information to the illumination control rule, and determines a lighting state of the illumination 113. The illumination management unit 130 generates illumination control information including the determined lighting state.

In the present example embodiment, the street lights 101 are controlled for each of the groups G_1 to G_6. Therefore, the street lights 101 to be controlled may be determined by group identification information for identifying the groups G_1 to G_6.

Herein, the illumination control rule is constituted of a condition when the illumination 113 is controlled, such as in what case and how, the illumination 113 is controlled, and a control method of the illumination 113. More specific examples are exemplified in the following. However, the following examples may be modified in various ways, and, for example, a combination of the condition and the control method may be modified as necessary.

(1) The illumination control rule includes controlling the illumination 113 in front of (specifically, a moving destination of) a person in a moving direction, in a case where there is a person in front of or behind the person in the moving direction, or in a case where there is a suspicious person in front of or behind the person in the moving direction. The illumination control rule may be applied to a case where a moving person is a woman.

The illumination management unit 130 in this case further refers to person information acquired by processing image information generated by the camera 111 of the street light 101 located in front of or behind a person in a moving direction, in a case where person information includes the moving direction of the person.

The illumination management unit 130 generates illumination control information by using the referred person information. The illumination management unit 130 transmits the generated illumination control information to the controllers 110 of the street lights 101 belonging to the target groups G1 to G6. Thus, the illumination management unit 130 controls a lighting state of the illuminations 113 of the street lights 101 belonging to the target groups G1 to G6 in a batch manner by using referred person information.

As a control method of the illumination 113, an example of setting the illumination 113 brighter than a standard illuminance can be exemplified. This makes it easy for another person to notice, and enables to improve safety of traffic.

Herein, the standard illuminance is an illuminance of the illumination 113 in a normal case where a person is passing, and is determined in advance as necessary.

(2) The illumination control rule includes controlling the illumination 113 near an area where a person and a vehicle may cross each other, in a case where there is a vehicle traveling in a direction intersecting a moving direction of a person. The case that there is a vehicle traveling in a direction intersecting a moving direction of a person is, for example, a case in FIG. 2 that there is a pedestrian moving in a Y plus direction on the road RA, and there is a vehicle traveling in an X plus direction on the road RC.

The illumination management unit 130 in this case refers to vehicle information acquired by processing image information generated by the camera 111 of the street light 101 located in a predetermined range from a person, in a case where person information includes a moving direction of the person.

The illumination management unit 130 generates illumination control information by using the referred vehicle information. The illumination management unit 130 transmits the generated illumination control information to the controllers 110 of the street lights 101 belonging to the target groups G1 to G6. Thus, the illumination control unit 130 controls a lighting state of the illuminations 113 of the street lights 101 belonging to the target groups G1 to G6 in a batch manner by using the referred vehicle information.

As a control method of the illumination 113, an example of setting the illumination 113 brighter than a standard illuminance can be exemplified. This makes it easy for both of a pedestrian and a driver to notice each other, and enables to improve safety of traffic.

(3) The illumination control rule includes controlling the illumination 113 near an area where a plurality of vehicles cross each other, in a case where there are a plurality of vehicles traveling toward the same intersection.

The illumination management unit 130 in this case refers to vehicle information acquired by processing image information generated by the camera 111 of the street light 101 located in a predetermined range from a vehicle, in a case where vehicle information includes the traveling vehicle.

The illumination management unit 130 generates illumination control information by using the referred vehicle information. The illumination management unit 130 transmits the generated illumination control information to the controllers 110 of the street lights 101 belonging to the target groups G1 to G6. Thus, the illumination management unit 130 controls a lighting state of the illuminations 113 of the street lights 101 belonging to the target groups G1 to G6 in a batch manner by using the referred vehicle information.

As an example of a control method of the illumination 113, an example of setting the illumination 113 brighter than a standard illuminance can be exemplified. This makes it easy for both of drivers to notice each other, and enables to improve safety of traffic.

(4) The illumination control rule includes controlling the illuminations 113 of the entirety of the street lights 101 in the area, in a case where the number of people who are not wearing a covering object for covering around the mouth is equal to or more than a predetermined threshold value, or in a case where the number of people who are opening an umbrella is equal to or more than a predetermined threshold value.

As a control method of the illumination 113, changing the color of the illumination 113, and setting the illumination 113 brighter than a standard illuminance can be exemplified. For example, in a case where the number of people who are not wearing a covering object for covering around the mouth is large, it is possible to avoid passage in the area as much as possible by changing the color of the illumination 113. Further, for example, in a case where the number of people who are opening an umbrella is large, it makes it easy to visually recognize a status of a road by setting the illumination 113 brighter than a standard illuminance. This enables to improve safety of traffic.

(5) The illumination control rule includes controlling the illumination 113 of the street light 101 installed in the area, in a case where a degree of congestion is equal to or more than a predetermined threshold value. As a control method of the illumination 113, changing the color of the illumination 113, and setting the illumination 113 brighter than a standard illuminance can be exemplified.

For example, by setting the color red when it is crowded, and setting the color green when it is relatively vacant, a pedestrian can know a congestion status even from afar, and can move along a desired route. Further, for example, by setting the illumination 113 brighter than a standard illuminance when it is crowded, it makes it easy to visually recognize the surroundings even when it is crowded. This enables to improve safety of traffic.

(6) The illumination control rule includes controlling the illumination 113 in an area where a wheelchair is detected, and in front of (specifically, a moving destination of) the wheelchair in a moving direction, in a case where wheelchair information is included. As a control method of the illumination 113, changing the color of the illumination 113, and setting the illumination 113 brighter than a standard illuminance can be exemplified. This makes it easy to move in a wheelchair, and makes it easy to recognize a wheelchair also from the surroundings. This enables to improve safety of traffic.

(7) The illumination control rule includes controlling the illumination 113 in an area where a target person is detected, and in front of (specifically, a moving destination of) the person in a moving direction, in a case where there is a person whose age group satisfies a predetermined criterion. The person whose age group satisfies a predetermined criterion is, for example, a child of a predetermined age group or younger than the age group, and an elderly person of a predetermined age group or older than the age group.

As a control method of the illumination 113, changing the color of the illumination 113, and setting the illumination 113 brighter than a standard illuminance can be exemplified. This makes it easy for the target person to move, and makes it easy for a surrounding person to notice the person. This enables to improve safety of traffic.

(8) The illumination control rule includes controlling the illumination 113 in an area where a target person is detected, and in front of (specifically, a moving destination of) the person in a moving direction, in a case where there is a predetermined person. As described above, the predetermined person is, for example, a VIP, a criminal, and the like.

As a control method of the illumination 113, setting the illumination 113 brighter than a standard illuminance in case of a VIP can be exemplified. This makes it easy for the target person to move. This enables to improve safety of traffic.

Further, in a case of a criminal, changing the color of the illumination 113 can be exemplified. This makes it easy for a surrounding person to notice the person, and a measure for avoiding a danger such as reporting to the police can be taken. This enables to improve safety of traffic.

(8) The illumination control rule includes controlling the illumination 113 in an area where a target event has occurred, and in front of (specifically, a moving destination of) a person moving from the area in a moving direction, in a case where event occurrence information has been acquired.

As a control method of the illumination 113, changing the color of the illumination 113, setting the illumination 113 brighter than a standard illuminance, and blinking the illumination 113 can be exemplified.

This makes it easy for a surrounding person to notice a person or a vehicle that has become a cause of the event, and a measure for avoiding a danger such as reporting to the police can be taken. This enables to improve safety of traffic.

Note that, a lighting state of the illumination 113 of the street light 101 installed in an area of a predetermined range with respect to a detected area may be changed, in place of changing a lighting state of the illumination 113 in a moving destination in the foregoing examples.

The illumination management unit 130 transmits the illumination control information generated in step S302 to the controller 110 of the target street light 101 determined in step S302 (step S303), and finishes the illumination management processing. At this occasion, the illumination control information is transmitted to the controllers 110 of all the street lights 101 belonging to the groups G_1 to G_6 determined in step S302. Thus, a lighting state of the illuminations 113 of all the street lights 101 belonging to the groups G_1 to G_6 can be controlled in a batch manner.

### (Output Management Processing)

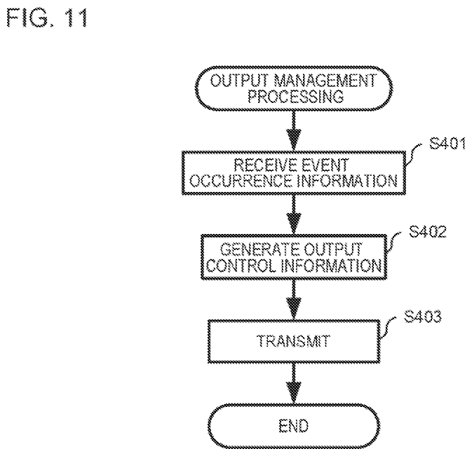

FIG. 11 is a flowchart illustrating one example of the output management processing according to the present example embodiment. The output management processing is processing for controlling the output unit 114 provided in the target street light 101, and is performed by the management apparatus 102.

The output management unit 131 receives person information, vehicle information, and event occurrence information transmitted in steps S104 and S204 via the network N (step S401). The output management unit 131 holds the received event occurrence information.

The output management unit 131 generates output control information for controlling the output unit 114 (each of the display unit 114a and the speaker 114b) provided in the target street light 101, based on the event occurrence information received in step S401 (step S402).

More specifically, for example, the output management unit 131 holds in advance an output control rule in which a control method of the output unit 114 according to event occurrence information is defined. The illumination management unit 130 determines the street light 101 to be controlled by applying the event occurrence information, the street light 101 serving as a transmission source of the event occurrence information to the output control rule, and determines a control method of the output unit 114. The illumination management unit 130 generates output control information including the determined control method. The control method includes, for example, image determination information for determining an image to be displayed on the display unit 114a, and audio determination information for determining an audio sound to be output to the speaker 114b.

Herein, the output control rule is constituted of a condition when the output unit 114 is controlled, such as in what case and how, the output unit 114 is controlled, and a control method of the output unit 114.

As a condition when the output unit 114 is controlled, for example, some or all of the conditions when the illumination 113 is controlled may be applied. The condition when the output unit 114 is controlled may include a condition different from a condition when the illumination 113 is controlled.

A control method of the output unit 114 includes, for example, at least one of displaying an image representing a phenomenon (specifically, a content of the above-described condition) that has become a cause of controlling the illumination 113 or the output unit 114, and outputting a sound according to the phenomenon. Note that, displaying an image includes displaying a character.

The output management unit 131 transmits the output control information generated in step S402 to the controller 110 of the target street light 101 determined in step S402 (step S403), and finishes the illumination management processing.

### (Illumination Control Processing)

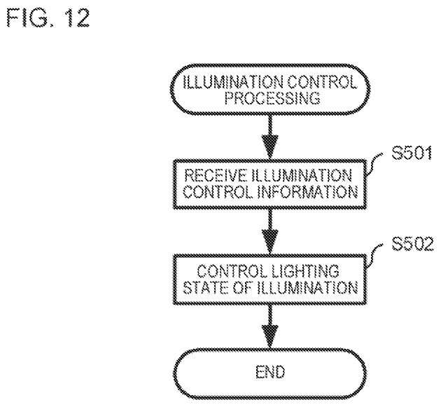

FIG. 12 is a flowchart illustrating one example of the illumination control processing according to the present example embodiment. The illumination control processing is processing for controlling a lighting state of the illumination 113 in the street light 101.

The illumination control unit 122 receives the illumination control information transmitted in step S303 (step S501).

The illumination control unit 122 controls a lighting state of the illumination 113 according to the illumination control information received in step S501 (step S502), and finishes the illumination control processing.

### (Output Control Processing)

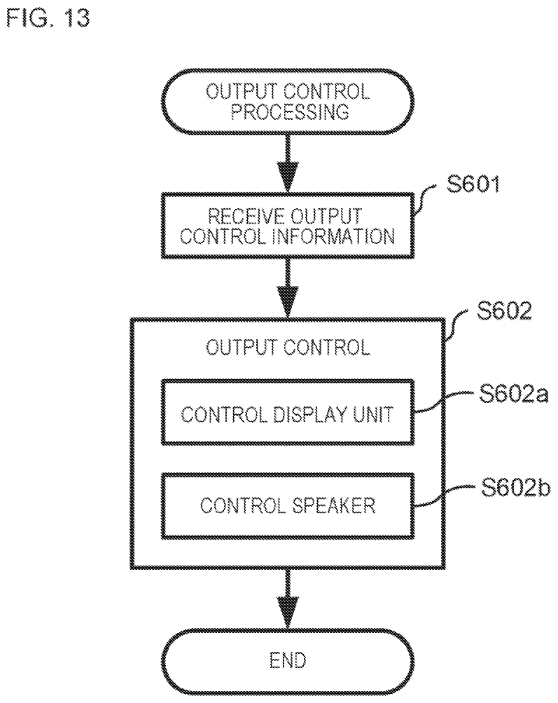

FIG. 13 is a flowchart illustrating one example of the output control processing according to the present example embodiment. The output control processing is processing for controlling the output unit 114 (each of the display unit 114a and the speaker 114b) in the street light 101.

The output control unit 123 receives the output control information transmitted in step S403 (step S601).

The output control unit 123 performs the output control processing according to the output control information received in step S601 (step S602).

More specifically, the display control unit 123a causes the display unit 114a to display an image to be determined by image determination information, in a case where output control information includes the image determination information (step S602a). Further, the speaker control unit 123b causes the speaker 114a to output an audio sound to be determined by audio determination information, in a case where output control information includes the audio determination information (step S602b).

Herein, image information associated with image determination information may be held in advance in the display control unit 123a, and audio information associated with audio determination information may be held in advance in the speaker control unit 123b.

Thus, the output control unit 123 finishes the output control processing.

### (Operation State Control Processing)

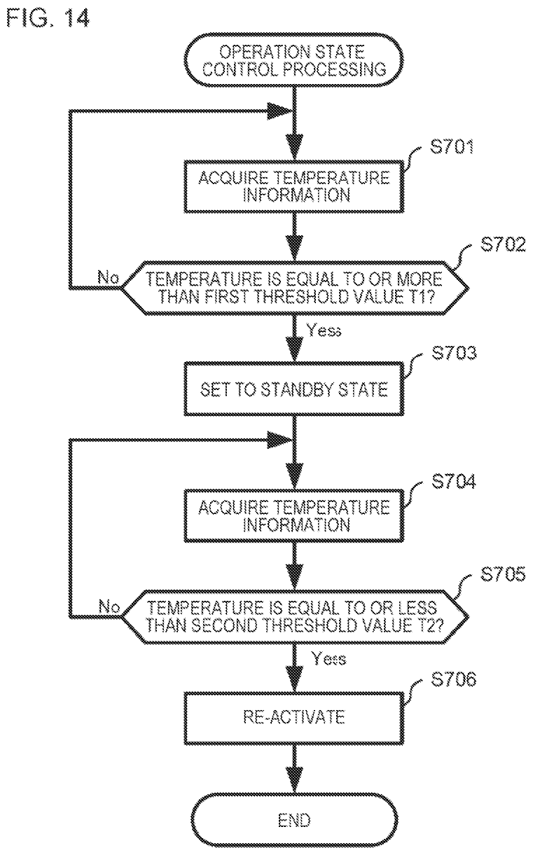

FIG. 14 is a flowchart illustrating one example of the operation state control processing according to the present example embodiment. The operation state control processing is processing for controlling an operation state of the controller 110. The operation state control processing is repeatedly performed during a time when electric power is turned on in each of the street lights 101.

The operation state control unit 124 acquires temperature information from the temperature sensor 112b (step S701).

The operation state control unit 124 determines whether a temperature included in the temperature information acquired in step S701 is equal to or more than the first threshold value T1 [° C.] (step S702). In a case where the temperature included in the temperature information is not equal to or more than the first threshold value T1 [° C.] (step S702; No), the operation state control unit 124 performs the processing of step S701 again.

In a case where the temperature included in the temperature information is equal to or more than the first threshold value T1 [° C.] (step S702; Yes), the operation state control unit 124 sets the operation state of the controller 110 to a standby state (step S703).

The operation state control unit 124 acquires the temperature information from the temperature sensor 112b (step S704).

The operation state control unit 124 determines whether the temperature included in the temperature information acquired in step S704 is equal to or less than the second threshold value T2 [° C.] (step S705). In a case where the temperature included in the temperature information is not equal to or less than the second threshold value T2 [° C.] (step S705; No), the operation state control unit 124 performs the processing of step S704 again.

In a case where the temperature included in the temperature information is equal to or less than the second threshold value T2 [° C.] (step S705; Yes), the operation state control unit 124 re-activates the controller 110 (step S706). Thus, the operation state of the controller 110 is set to a normal state, and the operation state control processing is finished.

In the operation state control processing, when the temperature within the housing becomes equal to or more than the first threshold value T1 [° C.], the controller 110 is brought to a standby state. As described above, since this reduces heat dissipation accompanied by processing in the controller 110, it is possible to lower the temperature of the controller 110. Then, when the temperature within the housing becomes equal to or less than the second threshold value T2 [° C.], the controller 110 is re-activated, and is operated in a normal state.

In a time period when an external temperature is high like summer, the temperature in the housing may rise, and the controller 110 may be damaged by overheating. Performing the operation state control processing enables to prevent overheating of the controller 110. This enables to reduce a likelihood that the controller 110 may be damaged by heating.

In the foregoing, one example embodiment according to the present invention has been described, but the example embodiment may be modified as follows.

### Modification Example 1

Street lights 101 may not be grouped, but may be individually managed by a management apparatus 102. In this case, an illumination management unit 130 may control a lighting state of an illumination 113 provided in at least one of one or a plurality of the street lights 101 by using a processing result of image information.

### Modification Example 2

In a case where a street light 101 is provided near a river such as a bank, a camera 111 may photograph the river, and an image processing unit 111 may generate water level information indicating a water level of the river, as a processing result of image information. Further, in a case where a sensor 112 includes a water level sensor, and water level information exceeds a predetermined water level, an event detection unit 121 may generate event occurrence information indicating that the water level is a dangerous water level.

Then, in a case where the water level information exceeds the predetermined water level, an illumination management unit 130 may generate illumination control information, and transmit the illumination control information to a controller 110 of a street light 101 installed in an area where an elevation is low such as an underpass. The illumination control information at this occasion may be, for example, information for setting an illumination 113 brighter than a standard illuminance, or may be information for changing the color of the illumination 113 to red or the like.

Further, an output management unit 131 may generate output control information, and transmit the output control information to the controller 110 of the street light 101 installed in an area where the elevation is low such as an underpass. The output control information at this occasion may be, for example, information for outputting an image or an audio sound for informing that the water level is a dangerous water level.

This allows a person near the river to know that the river has reached the dangerous water level, and avoid the place. This enables to improve safety of traffic.

### Modification Example 3

The example embodiment has described an example in which the output management unit 131 holds in advance an output control rule in which a control method of the output unit 114 according to event occurrence information is defined, and generates output control information, based on the event occurrence information.

However, the output control rule is not limited to a control method of the output unit 114 according to event occurrence information, but a control method of the output unit 114 according to at least one of event occurrence information, person information, and vehicle information may be held in advance. Thus, the output management unit 131 may generate output control information, based on at least one of event occurrence information, person information, and vehicle information.

### Modification Example 3-1

As one example of the modification example 3, an output management unit 131 may hold in advance an output control rule for causing an output unit 114 to output a predetermined advertisement. Thus, for example, in step S402, the output management unit 131 may generate output control information for causing the output unit 114 provided in a target street light 101 to output an advertisement, based on person information. The output at this occasion may be performed by at least one of a display unit 114a and a speaker 114b.

As a more specific example, an output control rule may include an advertisement associated with either or both of an age group and a gender. In this case, the output management unit 131 may generate output control information for causing the output unit 114 to output an advertisement, based on either or both of an age group and a gender included in person information.

This allows the output unit 114 to output an advertisement associated with, for example, an age group in which the number of people included in person information is largest; a combination of an age group in which the number of people included in person information is largest, and a gender; and the like. This enables to select and output in real time an advertisement in which a high sales promotion effect can be expected according to a person passing on a road.

### Modification Example 3-2

Further, as another example of the modification example 3, an output management unit 131 may hold in advance an output control rule for causing an output unit 114 to output a message associated with either or both of a wearing rate of a covering object such as a mask for covering around the mouth, and a congestion degree. The wearing rate of the covering object is a ratio of persons wearing the covering object with respect to persons included in person information.

In this case, the output management unit 131 may generate output control information for causing the output unit 114 to output, for example, a message encouraging a person passing on a road to wear a covering object, based on either or both of object information included in person information, and a congestion degree.

This enables to encourage to wear a covering object, in a case where there is a person who is not wearing the covering object, in a case where a predetermined number or ratio of persons who are not wearing the covering object are present in a more crowded condition than a predetermined congestion degree, or the like. This enables to prevent spread of infection of an infectious disease.

Further, an output control rule may be defined in such a way as to change a color, a size, a content, or the like of a message to be output according to the number or a ratio of persons who are not wearing a covering object. This enables to encourage to wear a covering object with a strength according to a condition of people passing on a road. This enables to more effectively prevent spread of infection of an infectious disease.

### Modification Example 3-3

As yet another example of the modification example 3, an output management unit 131 may hold in advance an output control rule for causing an output unit 114 to output a message associated with that there is a person moving in a wheelchair. In this case, the output management unit 131 may generate output control information for causing the output unit 114 to output, for example, a message informing a person passing on a road that there is a person moving in a wheelchair, based on wheelchair information included in person information.

This allows another passer-by to notice a person moving in a wheelchair, for example, in a case where there is a person moving in a wheelchair. This enables to improve safety of passing on a road.

### Modification Example 4

The example embodiment has been described by way of the street light 101 illustrated in FIG. 3, as an example. However, the illustrated street light 101 is merely one example, and the shape of the housing, a location where each component 110 to 114 is provided in the housing, and the like may be modified as necessary. Further, as the sensor 112, a humidity sensor, an air pollution sensor, a vibration sensor, a tilt sensor, a water sensor, and the like may be provided, in addition to the illuminance sensor 112a, the microphone 112b, and the temperature sensor 112c. Herein, the air pollution sensor is a sensor for measuring floating matter in the air such as PM 2.5. Further, the water sensor is a sensor for detecting submergence, measuring a water level, and the like.

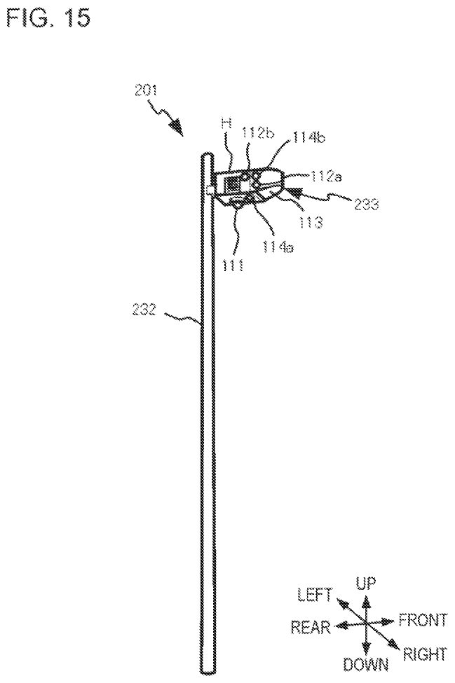

FIG. 15 illustrates one example of an external appearance of a street light 201 according to a modification example 4. The street light 201 includes a pole unit 232, and an illumination unit 233. The pole unit 232 is a pole extending in an up-down direction, and, for example, wiring or the like may be provided inside the pole unit 232 as necessary.

The illumination unit 233 is a unit to be mounted near an upper end of the pole unit 232, and protrudes forward.

An illumination 113, a controller 110, a camera 111, a speaker 114b, a microphone 112a, a display unit 114a, and a temperature sensor 112b similar to those of the street light 101 according to the example embodiment 1 are provided in a housing H of the illumination unit 233. The display unit 114a projects an image, for example, on a road surface of a road. FIG. 16 is a cross-sectional view of the illumination unit 233 according to the modification example 4 substantially at a middle in a left-right direction, and the controller 110 is accommodated inside the housing H. Also according to the present modification example, a similar advantageous effect to that of the example embodiment is provided.

Note that, the illumination unit 233 may be mounted on an existing pole, utility pole, or the like, as a street light. This makes it easy to install a street light.

In the foregoing, an example embodiment and modification examples according to the present invention have been described with reference to the drawings, however, these are examples of the present invention, and various configurations other than the above can also be adopted.

Further, in the plurality of flowcharts used in the above description, a plurality of processes (pieces of processing) are described in order, but an order of execution of processes to be performed in each example embodiment is not limited to the order of description. In each example embodiment, the order of illustrated processes can be changed within a range that does not adversely affect a content. Further, the above-described example embodiment and modification examples can be combined, as far as contents do not conflict with each other.

A part or all of the above-described example embodiment may also be described as the following supplementary notes, but is not limited to the following.

1. A street light system including:
an image processing unit that generates person information relating to a plurality of persons included in image information by processing the image information to be generated by a camera provided in each of one or a plurality of street lights; and
an illumination management unit that controls a lighting state of an illumination provided in at least one of the one or the plurality of street lights by using a processing result of the image information.

2. The street light system according to supplementary note 1, wherein the person information includes people flow information being information relating to a flow of people.

3. The street light system according to supplementary note 2, wherein
the street light is a plurality of street lights, and,
in a case where the person information includes a moving direction of a person, the illumination management unit further refers to the person information acquired by processing image information generated by a camera of a street light located in front of or behind the person in a moving direction, and controls a lighting state of an illumination provided in at least one of the one or the plurality of street lights by using the referred person information.

4. The street light system according to supplementary note 2 or 3, wherein
the street light is a plurality of street lights,
the image processing unit further generates vehicle information relating to movement of a vehicle included in the image information by processing the image information, and,
in a case where the person information includes a moving direction of a person, the illumination management unit refers to the vehicle information acquired by processing image information generated by a camera of a street light located in a predetermined range from the person, and controls a lighting state of an illumination provided in at least one of the one or the plurality of street lights by using the referred vehicle information.

5. The street light system according to any one of supplementary notes 1 to 4, wherein the person information includes at least one of object information relating to an object carried by a person, a congestion degree indicating a degree of congestion of people, wheelchair information relating to a person moving by a wheelchair, and attribute information indicating an attribute of a person.

6. The street light system according to supplementary note 5, wherein
the attribute includes at least one of a gender, an age group, whether to be a predetermined person, whether to be a criminal, and whether to be a suspicious person.

7. The street light system according to any one of supplementary notes 1 to 6, further including
an event detection unit that detects occurrence of a predetermined event by using sensor information from a sensor provided in each of the one or the plurality of street lights, wherein,
in a case where occurrence of the event is detected, the illumination management unit further controls a lighting state of an illumination provided in at least one of the one or the plurality of street lights.

8. The street light system according to supplementary note 7, wherein the sensor detects a sound.

9. The street light system according to any one of supplementary notes 1 to 8, wherein
the street light is a plurality of street lights, and the street lights are grouped according to an area where each of the street lights is installed, and
the illumination management unit controls a lighting state of an illumination provided in the street light for each of the groups by using a processing result of the image information.

10. The street light system according to any one of supplementary notes 1 to 9, wherein the lighting state includes at least one of brightness, blinking or continuous lighting, a blinking cycle in case of blinking, and a color.

11. The street light system according to any one of supplementary notes 1 to 10, further including:
an output unit that is provided in each of one or a plurality of street lights, and outputs at least one of an image and an audio sound; and
an output management unit that controls the output unit by using a processing result of the image information.

12. The street light system according to supplementary note 11, wherein
the output unit projects the image on a projection plane by using a road or another street light, as the projection plane.

13. A street light including:
an image processing unit that generates person information relating to a plurality of persons included in image information by processing the image information to be generated by a camera; and
an illumination control unit that controls a lighting state of an illumination according to illumination control information to be generated by using a processing result of the image information.

14. A street light management method including:
causing a controller provided in each of one or a plurality of street lights to generate person information relating to a plurality of persons included in image information by processing the image information to be generated by a camera provided in each of one or a plurality of street lights; and
causing a management apparatus capable of mutually communicating with the controller to control a lighting state of an illumination provided in at least one of the one or the plurality of street lights by using a processing result of the image information.

15. A program including:
a program for causing a controller provided in each of one or a plurality of street lights to generate person information relating to a plurality of persons included in image information by processing the image information to be generated by a camera provided in each of one or a plurality of street lights; and
a program for causing a management apparatus capable of mutually communicating with the controller to control a lighting state of an illumination provided in at least one of the one or the plurality of street lights by using a processing result of the image information.

This application is based upon and claims the benefit of priority from Japanese patent application No. 2021-091383, filed on May 31, 2021, the disclosure of which is incorporated herein in its entirety by reference.

### REFERENCE SIGNS LIST

100 Street light system
101, 101_1 to 101_20, 201 Street light
102 Management apparatus
N Network
110 Controller
111 Camera
112 Sensor
112a Illuminance sensor
112b Microphone
112c Temperature sensor
113 Illumination
114 Output unit
114a Display unit
114b Speaker
120 Image processing unit
121 Event detection unit
122 Illumination control unit
123 Output control unit
123a Display control unit
123b Speaker control unit
124 Operation state control unit
130 Illumination management unit
131 Output management unit
232 Pole unit
233 Illumination unit

What is claimed is:

1. A street light system comprising:
at least one memory configured to store instructions; and
at least one processor configured to execute the instructions to perform operations comprising:
generating person information relating to a plurality of persons included in image information by processing the image information to be generated by a camera provided in each of one or a plurality of street lights; and
controlling a lighting state of an illumination provided in at least one of the one or the plurality of street lights by using a processing result of the image information.

2. The street light system according to claim 1, wherein the person information includes people flow information being information relating to a flow of people.

3. The street light system according to claim 2, wherein
the street light is a plurality of street lights, and,
in a case where the person information includes a moving direction of a person, in controlling the lighting state of the illumination further referring to the person information acquired by processing image information generated by the camera of a street light located in front of or behind the person in a moving direction, and controlling the lighting state of the illumination provided in at least one of the one or the plurality of street lights by using the referred person information.

4. The street light system according to claim 2, wherein
the street light is a plurality of street lights,
in generating the person information further generating vehicle information relating to movement of a vehicle included in the image information by processing the image information, and,
in a case where the person information includes a moving direction of a person, in controlling the lighting state of the illumination referring to the vehicle information acquired by processing image information generated by a camera of a street light located in a predetermined range from the person, and a controlling the lighting state of the illumination provided in at least one of the one or the plurality of street lights by using the referred vehicle information.

5. The street light system according to claim 1, wherein the person information includes at least one of object information relating to an object carried by a person, a congestion degree indicating a degree of congestion of people, wheelchair information relating to a person moving by a wheelchair, and attribute information indicating an attribute of a person.

6. The street light system according to claim 1, further comprising
detecting occurrence of a predetermined event by using sensor information from a sensor provided in each of the one or the plurality of street lights, wherein,
in a case where occurrence of the event is detected, in controlling the lighting state of the illumination further controlling the lighting state of the illumination provided in at least one of the one or the plurality of street lights.

7. The street light system according to claim 1, wherein
the street light is a plurality of street lights, and the street lights are grouped according to an area where each of the street lights is installed, and
in controlling the lighting state of the illumination controlling the lighting state of the illumination provided in the street light for each of the groups by using a processing result of the image information.

8. The street light system according to claim 1, further comprising:
controlling an output device by using a processing result of the image information,
wherein the output device is provided in each of one or the plurality of street lights, and outputs at least one of an image and an audio sound.

9. The street light system according to claim 8, wherein the output device projects the image on a projection plane by using a road or another street light, as the projection plane.

10. A street light comprising:
at least one memory configured to store instructions; and
at least one processor configured to execute the instructions to perform operations comprising:
generating person information relating to a plurality of persons included in image information by processing the image information to be generated by a camera; and
controlling a lighting state of an illumination according to illumination control information to be generated by using a processing result of the image information.

11. (canceled)

12. A non-transitory storage medium storing a program comprising:
a program for causing a controller provided in each of one or a plurality of street lights to generate person information relating to a plurality of persons included in image information by processing the image information to be generated by a camera provided in each of one or a plurality of street lights; and
a program for causing a management apparatus capable of mutually communicating with the controller to control a lighting state of an illumination provided in at least one of the one or the plurality of street lights by using a processing result of the image information.

13. The street light according to claim 10, wherein the person information includes people flow information being information relating to a flow of people.

14. The street light according to claim 13, wherein
the street light is a plurality of street lights, and,
in a case where the person information includes a moving direction of a person, in controlling the lighting state of the illumination further referring to the person information acquired by processing image information generated by the camera of a street light located in front of or behind the person in a moving direction, and controlling the lighting state of the illumination provided in at least one of the one or the plurality of street lights by using the referred person information.

15. The street light according to claim 13, wherein
the street light is a plurality of street lights,
in generating the person information further generating vehicle information relating to movement of a vehicle included in the image information by processing the image information, and,
in a case where the person information includes a moving direction of a person, in controlling the lighting state of the illumination referring to the vehicle information acquired by processing image information generated by a camera of a street light located in a predetermined range from the person, and controlling the lighting state of the illumination provided in at least one of the one or the plurality of street lights by using the referred vehicle information.

16. The street light according to claim 10, wherein the person information includes at least one of object information relating to an object carried by a person, a congestion degree indicating a degree of congestion of people, wheelchair information relating to a person moving by a wheelchair, and attribute information indicating an attribute of a person.

17. The non-transitory storage medium according to claim 12, wherein the person information includes people flow information being information relating to a flow of people.

18. The non-transitory storage medium according to claim 17, wherein
the street light is a plurality of street lights, and,
in a case where the person information includes a moving direction of a person, in controlling the lighting state of the illumination further referring to the person information acquired by processing image information generated by the camera of a street light located in front of or behind the person in a moving direction, and controlling the lighting state of the illumination provided in at least one of the one or the plurality of street lights by using the referred person information.

19. The non-transitory storage medium according to claim 17, wherein
the street light is a plurality of street lights,
in generating the person information further generating vehicle information relating to movement of a vehicle included in the image information by processing the image information, and,
in a case where the person information includes a moving direction of a person, in controlling the lighting state of the illumination referring to the vehicle information acquired by processing image information generated by a camera of a street light located in a predetermined range from the person, and controlling the lighting state of the illumination provided in at least one of the one or the plurality of street lights by using the referred vehicle information.

20. The non-transitory storage medium according to claim 12, wherein the person information includes at least one of object information relating to an object carried by a person, a congestion degree indicating a degree of congestion of people, wheelchair information relating to a person moving by a wheelchair, and attribute information indicating an attribute of a person.
